(19) United States
(12) Patent Application Publication
(10) Pub. No.: US 2009/0266721 A1
(43) Pub. Date: Oct. 29, 2009

(54) SCHOOL MANAGEMENT SYSTEM

(76) Inventor: Bukurie Bala, Sarasota, FL (US)

Correspondence Address: VENABLE LLP, P.O. BOX 34385, WASHINGTON, DC, 20043-9998, US

(21) Appl. No.: 12/429,871

(22) Filed: Apr. 24, 2009

Related U.S. Application Data
(60) Provisional application No. 61/125,689, filed on Apr. 28, 2008.

(51) Int. Cl. A45C 11/34; G09D 3/00; G09F 3/20; B43L 1/00; B65D 85/28

(52) U.S. Cl. 206/214; 40/107; 40/661; 434/422; 206/371; 206/350

(57) ABSTRACT

A school organization system which may include a panel, a writing surface coupled to the panel, a clear window coupled to the panel, a first folder coupled to the panel; and a second folder coupled to the panel. The writing surface may include a magnetic re-writable writing surface. The writing surface may include a flexible magnetic dry erase board. The writing surface may include an approximately letter sized blank writing surface and a permanent calendar. The clear window and the panel may be coupled to define an opening between the clear window and the panel for inserting a document thereto via a side of the clear window. The opening between the clear window and the panel may be oriented horizontally. The first folder may include a clear label window coupled to a front side of the first folder.

### CROSS-REFERENCE TO RELATED APPLICATIONS

This application claims the benefit of the following related application: U.S. Provisional Patent Application Ser. No. 61/125,689, filed on Apr. 28, 2008, the contents of which are incorporated herein by reference in their entirety.

### BACKGROUND

On a daily basis, parents of children attending school have to deal with various papers their children bring to and from school. The number and variety of information parents must manage with can be overwhelming. School papers may be kept in files or folders to as a form of management for the papers, however children may not want to use files and a parent may be inconvenienced by the need to search for files for papers.

Besides the management of paper, parents also need to manage their children's busy schedules. The dates of various events may be important to remember, such as, e.g., dates assignments are due, when school field trips are conducted, and when parent teacher conferences are held Papers noting dates of events but filed away in folders risk being forgotten.

What is needed is a school management system that overcomes the shortcomings of conventional management systems.

### SUMMARY

The present invention sets forth various exemplary embodiments of apparatuses and systems for organizing school documents.

According to an exemplary embodiment of the present invention, a school organization system may include a panel, a writing surface coupled to the panel, a clear window coupled to the panel, a first folder coupled to the panel, and a second folder coupled to the panel.

According to an exemplary embodiment of the present invention, the writing surface may include a magnetic re-writable writing surface.

According to an exemplary embodiment of the present invention, the writing surface may include a flexible magnetic dry erase board.

According to an exemplary embodiment of the present invention, the writing surface may include a permanent calendar displayed on a re-writable surface.

According to an exemplary embodiment of the present invention, the writing surface may include an approximately letter sized blank writing surface and the permanent calendar may include a grid.

According to an exemplary embodiment of the present invention, the permanent calendar may include a 5 by 7 grid of blocks for dates, wherein a day of a week is displayed on the top of each column in the grid.

According to an exemplary embodiment of the present invention, the clear window and the panel may be coupled to define an opening between the clear window and the panel for inserting a document thereto via a side of the clear window.

According to an exemplary embodiment of the present invention, the opening between the clear window and the panel may be oriented horizontally.

According to an exemplary embodiment of the present invention, the first folder may include a clear label window coupled to a front side of the first folder.

According to an exemplary embodiment of the present invention, the clear label window may be coupled on the top and bottom of the window to the first folder so a label may be inserted between the clear label window and the front side of the first folder.

According to an exemplary embodiment of the present invention, the school organization system may further include a clear pocket for storing utensils coupled to the panel.

According to an exemplary embodiment of the present invention, the clear pocket may be coupled to the panel to define an opening between the clear pocket and the panel for storing the utensils therein via a top of the clear pocket.

According to an exemplary embodiment of the present invention, the panel further include a metal reinforced hole for hanging the panel.

According to an exemplary embodiment of the present invention, the school organization system may further include a utensil pocket coupled to the panel for storing a writing instrument for writing on the writing surface.

According to an exemplary embodiment of the present invention, the school organization system may further include two or more straps coupled to the panel for storing a large paper.

According to an exemplary embodiment of the present invention, the two or more straps may include two or more straps operable to detachably fasten the large paper.

According to an exemplary embodiment of the present invention, a material for creating the school organization system may be canvas.

According to an exemplary embodiment of the present invention, a school organization system may include a panel approximately 28.5″ wide by 36″ long, a writing surface approximately 21″ wide by 11″ long coupled to the panel in approximately the center of the panel 1″ below a top side of the panel, a clear window approximately 14″ wide by 9″ long coupled to the panel in approximately the center of the panel below the writing surface, a first folder approximately 14″ wide by 9″ long coupled to the panel at a bottom portion of the panel below the writing surface and below the clear window, and a second folder approximately 14″ wide by 9″ long coupled to and overlapping at least a bottom portion of the first folder and coupled to the panel.

According to an exemplary embodiment of the present invention, a school organization system may include means for re-usably writing notes coupled to a panel, means for organizing a schedule coupled to the panel, means for displaying a document coupled to the panel, means for storing and displaying a plurality of utensils coupled to a panel, and means for storing a legal sized paper coupled to the panel.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of various exemplary embodiments, including a preferred embodiment of the invention, as illustrated in the accompanying drawings wherein like reference numbers generally indicate identical, functionally similar, and/or structurally similar elements.

FIG. 1 depicts an exemplary frontal view of an exemplary embodiment of the present invention;

FIG. 2 depicts an exemplary back view of an exemplary embodiment of the present invention; and

FIG. 3 depicts an exemplary close up view of a writing surface according to an exemplary embodiment of a of the present invention.

### DETAILED DESCRIPTION OF EXEMPLARY EMBODIMENTS OF THE PRESENT INVENTION

A preferred and various other exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

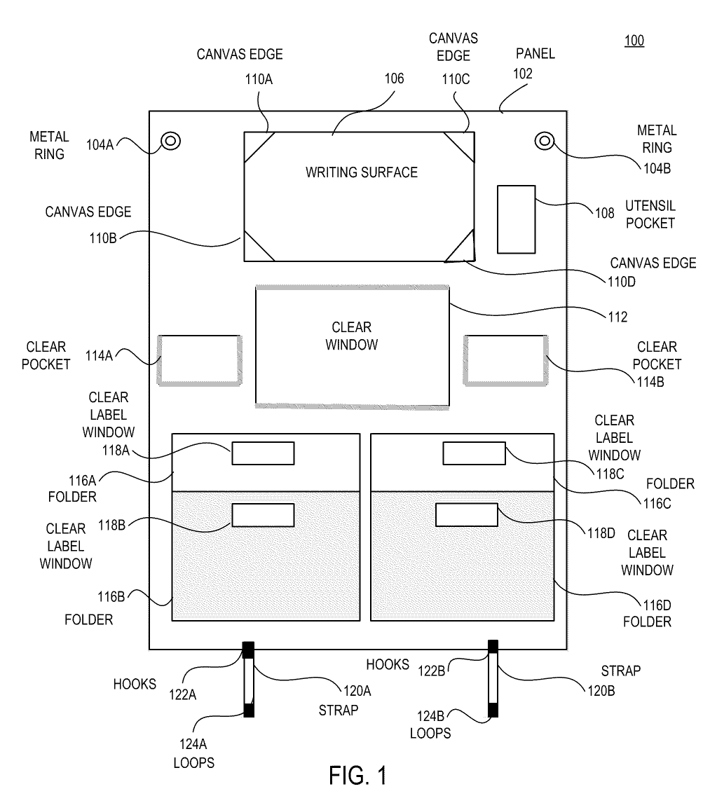

FIG. 1 depicts an exemplary frontal view of an exemplary embodiment of the present invention. According to an exemplary embodiment, the school management system 100 may be an “all-inclusive” system providing parents and children a central system for managing school related matters. In an exemplary embodiment, the school management system 100 may be a “behind the door” or “on the wall” hanging management system. According to an exemplary embodiment, the school management system 100 may be based on a panel 102 and may include a multitude of devices, apparatuses, and/or structures for organizing and simplifying homework and school papers.

According to an exemplary embodiment, the school management system 100 may include a panel 102. In an exemplary embodiment, the panel 102 may include metal rings 104a and 104b (hereinafter collectively referred to as 104) to hang the panel 102.

According to an exemplary embodiment, the panel 102 may also include a writing surface 106 for users to write notes and/or assignments. In an exemplary embodiment, the writing surface 106 may be held in place by canvas edges 110A, 110B, 110C and 110D (hereinafter collectively referred to as 110).

According to an exemplary embodiment, the panel 106 may also include a utensil pocket 108 for storing items, e.g., a writing instrument for writing on the writing surface 106. In an exemplary embodiment, the panel 106 may include one or more clear pockets 114A and 114B (hereinafter collectively referred to as 114) to store various utensils and/or devices.

According to an exemplary embodiment, the panel 106 may include a clear window 112 for displaying papers. In an exemplary embodiment, the panel 106 may include one or more pockets for papers 116A, 116B, 116C, 116D (hereinafter collectively referred to as 116).

According to an exemplary embodiment, the panel 106 may also include one or more canvas strips 120A and 120B (hereinafter collectively referred to as 120) for storing large papers.

In an exemplary embodiment, the panel 102 may be made of a canvas material. According to an exemplary embodiment, the panel 102 may be approximately 28.5″ wide and 36″ long so that various structures may fit on the panel 106. In an exemplary embodiment, the panel 102 may be sized so it may suit the back of the 32″ width of an exemplary typical door.

In an exemplary embodiment, the panel 102 may include one or more structures for the panel 102 to be attached and/or removably attached to various surfaces. According to an exemplary embodiment, the panel 102 may be hung to a wall or a door, through two approximately ½″ wide holes 104 located at the top of each corner of the panel 102, 1″ down from the top edge and 1″ in from the outer edges. In an exemplary embodiment, the holes 104 may be reinforced with a metal ring inserted in their middle. In an exemplary embodiment, the metal rings 104 may be sized so hooks may be inserted into the metal rings 104 to support the panel 102.

According to an exemplary embodiment, the panel 102 may also include a writing surface 106. In an exemplary embodiment, the writing surface 106 may be used to write notes and/or assignments on the writing surface 106. According to an exemplary embodiment, the writing surface 106 may be a re-writeable surface, such as, e.g., but not limited to a dry erase board. According to an exemplary embodiment, the writing surface 106 may also be made of a magnetic material so magnets may be removably attached to the writing surface 106.

In an exemplary embodiment, the writing surface 106 may be affixed to the panel 102. According to an exemplary embodiment, the writing surface 106 may be removably coupled to the panel 102 by one or more corner edges 110. In an exemplary embodiment, the corner edges 110 may be canvas corner edges sewn the panel 102 by two perpendicular sides of each corner edge 110 so an opening may be defined between a diagonal side of each corner edge 110 and the panel 102. According to an exemplary embodiment, the writing surface 106 may be flexible so the writing surface may be inserted into the corner edges and/or removed from the corner edges. According to an exemplary embodiment, the writing surface 106 may be located 1″ from the top edge of the panel 102 and horizontally centered. In an exemplary embodiment, the writing surface 106 may be a rectangular shape 21″ long by 11″ high.

According to an exemplary embodiment, the panel 102 may also include a utensil pocket 108. In an exemplary embodiment, the utensil pocket 108 may be used to store a writing instrument for the utensil pocket 108, such as, e.g., but not limited to, a dry erase marker. According to an exemplary embodiment, the utensil pocket 108 may be located approximately 1″ to the right of the writing surface 106. According to an exemplary embodiment, the utensil pocket 108 may be approximately 2″ long by 3″ high. In an exemplary embodiment, the utensil pocket 108 may be machine sewn on the bottom, right and left sides, leaving the top of the utensil pocket 108 open for inserting the marker. According to an exemplary embodiment, the utensil pocket 108 may be made out polyester material.

According to an exemplary embodiment, the panel 102 may include a clear window 112 for displaying a document, such as, e.g., but not limited to, a lunch menu. In an exemplary embodiment, the clear window 112 may be directly aligned under the dry erase board. According to an exemplary embodiment, the clear window 112 may be 14″ long by 9″ high. In an exemplary embodiment, the clear window 112 may be made of clear plastic material. According to an exemplary embodiment, the top and bottom of the clear window 112 may be machine sewn to the panel 102. In an exemplary embodiment, the clear window 112 may have a reinforced 1″ canvas trim sewn at the top and bottom edges of the clear window 112 to the panel 106 for added reinforcement. According to an exemplary embodiment, the left and right sides of the clear window 112 may be left open for papers to be inserted and pulled out with ease.

According to an exemplary embodiment, the panel 102 may include one or more clear pockets 114 for storing utensils and/or devices. In an exemplary embodiment, a first clear pocket 114A may be located ½″ to the left of the clear window 112 and a second clear pocket 114B may be located ½″ to the right of the clear window 112. According to an exemplary embodiment, the clear pockets 114 may be 5″ long and 4″ high and may be made out of the same clear plastic material as the aforementioned clear window 112. In an exemplary embodiment, each clear pocket 114 may be affixed to the panel 102 in a similar manner as the clear window 112, with reinforced ¼″ trim. However, according to an exemplary embodiment, the sewn edges may be on the bottom, left and right sides of the pocket 114, leaving the top open to allow for storage of various school utensils, such as, e.g., but not limited to, pencils, glue sticks, ruler, scissors, and markers.

According to an exemplary embodiment, the panel 102 may include one or more folders 116 for storing materials, such as, e.g., but not limited to, loose-leaf papers, projects, and library books. According to an exemplary embodiment, the folders 116 may be sized so they may store legal-sized papers. In an exemplary embodiment, the folders 116 may be located approximately ¼″ underneath the clear window 112. According to an exemplary embodiment, the folders may be made of polyester material. In an exemplary embodiment, each folder may be approximately 14″ long and 9″ high. According to an exemplary embodiment, the panel may include 102 four folders 114, two on the left side of the panel 102 and two on the right of the panel.

According to an exemplary embodiment, the folders may be identical, or may only differ in color. In an exemplary embodiment, there may be defined a ⅛″ space in between the left and/or right sets of folders 114 to allow for double-stitched seams to be machine sewn at each of the sides and bottom of the four folders 114.

According to an exemplary embodiment, the tops of the folders 114 may include a zipper so the folder may be closed and/or locked. According to an exemplary embodiment, the bottom folders may overlap the top folders. In an exemplary embodiment, the bottom folders may overlap the top folders by approximately 5 inches, leaving only approximately 4 inches of the top folders exposed. According to an exemplary embodiment, overlapping of folders may condense the overall height of the panel 102 without sacrificing any usability.

According to an exemplary embodiment, each of the four folders 116 may have a clear label window 118a, 118b, 118c, and 118d (hereinafter collectively referred to as 118) for storing folder labels. In an exemplary embodiment, the clear label windows may be 3″ long by 1″ high and may be located 1″ down from the top edge of each of the folders in the horizontal center of the folder.

According to an exemplary embodiment, each of the clear label windows 118 may be machine sewn onto the face of each folder 116. In an exemplary embodiment, the clear label windows 118 may be sewn at their top edges and bottom edges to their respective folders 116 to allow for a label to be inserted through the left and right openings. According to an exemplary embodiment, a user may create and insert their own labels into the clear label windows 118.

According to an exemplary embodiment, the panel 102 may include one or more straps 120 for storing large papers. In an exemplary embodiment, the straps 120 may be located at the bottom of the panel 102 and may be spaced 12″ apart. According to an exemplary embodiment, the straps 120 may be 10″ long by 1″ wide and may detachably fasten a large paper. In an exemplary embodiment, the straps may fasten using buttons, tape, knots, magnets and/or hook and loop fasteners (e.g., Velcro®). In an exemplary embodiment, hooks 122A and 122B may be attached to a first portion of the straps and Velcro loops 124A and 124B may be attached to a second portion of the straps so each strap may detachably fasten by pressing the hooks and the loops together.

According to an exemplary embodiment, the hooks may be attached to the top portion of the strap 120 and the loops may be attached to a bottom portion of the strap 120. In an exemplary embodiment, large papers may be rolled up and stored by orienting the rolled paper parallel to the bottom edge of the panel 102 and perpendicular to the straps 120. The straps 120 may be roped and fastened around the rolled paper.

According to an exemplary embodiment, the fabric and color of various portions of the school management system 100 may be modified to be more appropriate for the target user. The colors used in the fabric may be modified to be age appropriate for all school age children, from pre-school to college. In an exemplary embodiment, the colors of the fabric may vary greatly. For younger aged children, vibrant primary colors may be used for a panel 102 geared towards general population. In another exemplary embodiment, a panel 102 geared towards girls may use hues of pinks and greens. Another exemplary embodiment of a panel 102 geared towards boys may use blues, greens and dark red. According to an exemplary embodiment, for older students in high school and college, the panel 102 may use more mature colors, plaids, stripes, solids, with a more varied color palette.

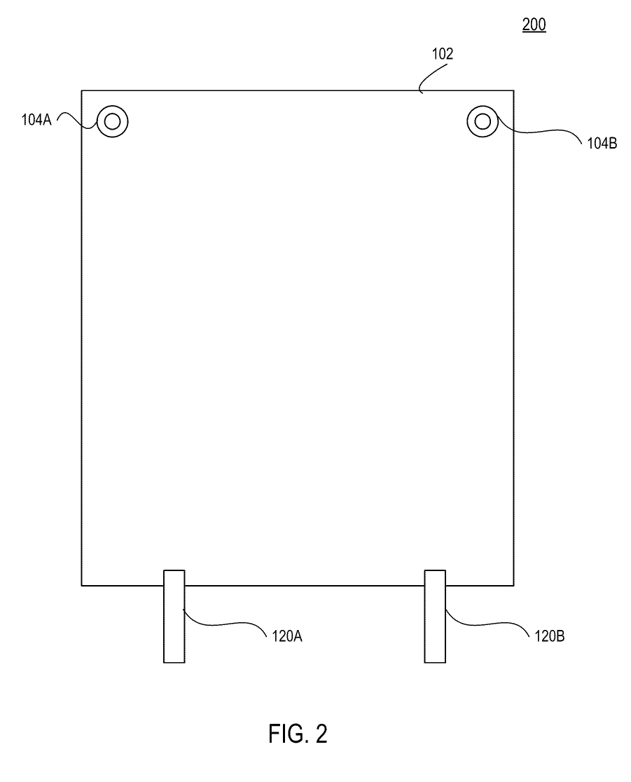

FIG. 2 depicts an exemplary back view 200 of an exemplary embodiment of the present invention. According to an exemplary embodiment, the back of the panel 102 may be bare. In an exemplary embodiment, the only features visible on the back of the panel 102 may be metal holes 104 and the straps 120. According to an exemplary embodiment, the back of the panel 102 may be made of a polyester material which may closely resemble canvas material used for the front of the panel 102.

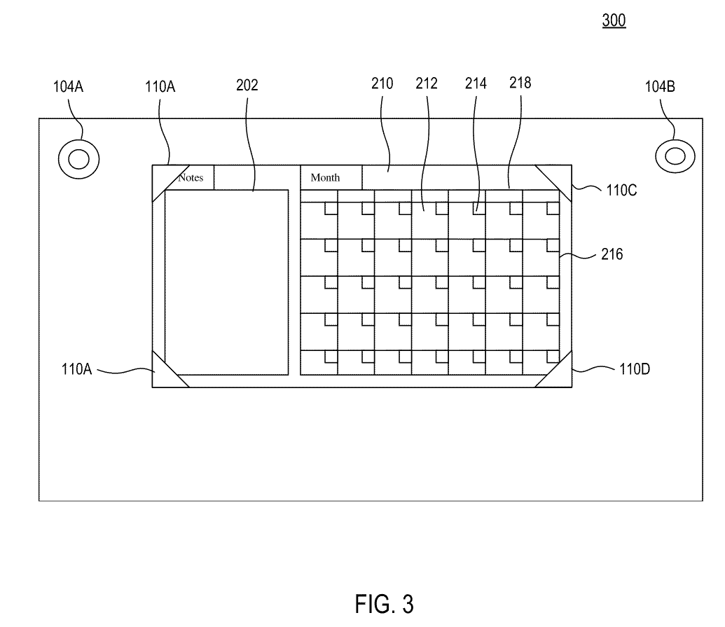

FIG. 3 depicts an exemplary close up view 300 of a writing surface 106 according to an exemplary embodiment of a of the present invention. According to an exemplary embodiment, the writing sample 106 may be a dry erase board and calendar combination. In an exemplary embodiment, the writing sample 106 may provide a re-usable surface on which a user may write notes and manage their schedule. According to an exemplary embodiment, the writing surface 106 may be a flexible magnetic re-writable surface. According to an exemplary embodiment, the writing surface 106 may have an approximately letter sized portion left blank 202 so a user may write notes in the blank portion. According to an exemplary embodiment, a calendar 210 may be displayed on the writing surface 106.

In an exemplary embodiment, the calendar 210 may be printed on the writing surface using permanent ink. According to an exemplary embodiment, the calendar may be a grid of boxes 212, each box 212 representing a generic day in a month. In an exemplary embodiment, a user may use the calendar to write dates and notations for each month, and may erase and re-use the calendar the next month. In an exemplary embodiment, inside each box 212 may be a smaller box 214 for a user to write the date corresponding to the box. According to an exemplary embodiment, each row 216 of boxes 212 may represent a week. In an exemplary embodiment, each column 218 of boxes 212 may represent a day of the week.

An exemplary embodiment of the school management system 100 may be The Homework Caddy.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A school organization system comprising:
a panel;
a writing surface coupled to said panel;
a clear window coupled to said panel;
a first folder coupled to said panel; and
a second folder coupled to said panel.

2. The school organization system of claim 1, wherein said writing surface comprises a magnetic re-writable writing surface.

3. The school organization system of claim 1, wherein said writing surface comprises a flexible magnetic dry erase board.

4. The school organization system of claim 1, wherein said writing surface comprises a permanent calendar displayed on a re-writable surface.

5. The school organization system of claim 4, wherein said writing surface comprises an approximately letter sized blank writing surface and said permanent calendar comprises a grid.

6. The school organization system of claim 1, wherein said permanent calendar comprises a 5 by 7 grid of blocks for dates, wherein a day of a week is displayed on the top of each column in said grid.

7. The school organization system of claim 1, wherein said clear window and said panel are coupled to define an opening between said clear window and said panel for inserting a document thereto via a side of said clear window.

8. The school organization system of claim 1, wherein said opening between said clear window and said panel is oriented horizontally.

9. The school organization system of claim 1, wherein said first folder comprises a clear label window coupled to a front side of said first folder.

10. The school organization system of claim 9, wherein said clear label window is coupled on the top and bottom of the window to said first folder so a label may be inserted between said clear label window and said front side of said first folder.

11. The school organization system of claim 1, further comprising a clear pocket for storing utensils coupled to said panel.

12. The school organization system of claim 11, wherein said clear pocket is coupled to said panel to define an opening between said clear pocket and said panel for storing the utensils therein via a top of said clear pocket.

13. The school organization system of claim 1, wherein said panel further comprises a metal reinforced hole for hanging said panel.

14. The school organization system of claim 1, further comprising a utensil pocket coupled to said panel for storing a writing instrument for writing on said writing surface.

15. The school organization system of claim 1, further comprising two or more straps coupled to said panel for storing a large paper.

16. The school organization system of claim 1, wherein said two or more straps comprise two or more straps operable to detachably fasten the large paper.

17. The school organization system of claim 1, wherein a material comprising said school organization system comprises canvas.

18. A school organization system comprising:
a panel approximately 28.5″ wide by 36″ long;
a writing surface approximately 21″ wide by 11″ long coupled to said panel in approximately the center of said panel 1″ below a top side of said panel;
a clear window approximately 14″ wide by 9″ long coupled to said panel in approximately the center of said panel below said writing surface;
a first folder approximately 14″ wide by 9″ long coupled to said panel at a bottom portion of said panel below said writing surface and below said clear window; and
a second folder approximately 14″ wide by 9″ long coupled to and overlapping at least a bottom portion of said first folder and coupled to said panel.

19. A school organization system comprising:
means for re-usably writing notes coupled to a panel;
means for organizing a schedule coupled to the panel;
means for displaying a document coupled to the panel;
means for storing and displaying a plurality of utensils coupled to a panel; and
means for storing a legal sized paper coupled to the panel.
